(19) United States
(12) Patent Application Publication
(10) Pub. No.: US 2016/0028269 A1
(43) Pub. Date: Jan. 28, 2016

(54) SYSTEM FOR WIRELESS EXCHANGE OF POWER BETWEEN MOBILE DEVICES

(71) Applicants: Eric Miller, Hollywood, FL (US); Jonathan Globerson, Sunny Isles Beach, FL (US)

(72) Inventors: Eric Miller, Hollywood, FL (US); Jonathan Globerson, Sunny Isles Beach, FL (US)

(21) Appl. No.: 14/808,284

(22) Filed: Jul. 24, 2015

Related U.S. Application Data
(60) Provisional application No. 62/029,088, filed on Jul. 25, 2014.

(51) Int. Cl. H02J 7/02; H04B 1/3883; H02J 7/04; H04W 52/02

(52) U.S. Cl. CPC H02J 7/025; H04W 52/0225; H04B 1/3883; H02J 7/04

(57) ABSTRACT

The present invention is a system for wireless charging comprising a first electronic mobile device and a second electronic mobile device, wherein each of said first and second electronic mobile devices are constructed and arranged to selectively transmit and receive power to a battery incorporated therewith.

### INDEX TO RELATED APPLICATIONS

This application is a non-provisional of and claims benefit to U.S. Provisional Patent Application Ser. No. 62/029,088 filed Jul. 25, 2014 the disclosure of which is incorporated herein by reference in its entirety.

### BACKGROUND OF THE INVENTION

The present invention relates generally to wireless charging of cell phones and other portable electronic devices.

### SUMMARY OF THE INVENTION

Although the figures and generalized description use cell phones, these examples are demonstrative only and the present invention is contemplated as being used on any combination of mobile electronic devices including, but not limited to, cameras, tablet computers, and the like.

In one embodiment, the present invention is a system for wireless charging comprising:
a first electronic mobile device;
a second electronic mobile device;
wherein each of said first and second electronic mobile devices are constructed and arranged to selectively transmit and receive power to a battery incorporated therewith.

In one embodiment, each of said first electronic mobile device and second electronic mobile device contains coils constructed and arranged to wirelessly send electrical power by transmitter to receiver via coupled inductors.

In one embodiment, the power is transferred from transmitter to receiver via a coupled magnetic field that is created when current flows through a transmitter coil.

In one embodiment, the electronic mobile device is a cell phone, smart phone, tablet computer, camera, microprocessor enabled hand-held device, or combinations thereof.

In one embodiment, the power transfer is initiated and stopped manually.

In one embodiment, the power transfer is initiated and stopped automatically. In the automatic embodiment, initiation and cessation of power transfer is governed by user selectable parameters including, but not limited to, battery power level of transmitting device, battery power level of receiving device, transfer rate, transfer time, or combinations thereof.

### BRIEF DESCRIPTION OF THE SEVERAL VIES OF THE DRAWINGS

FIG. 1 shows proximity of two phones for wireless charging.

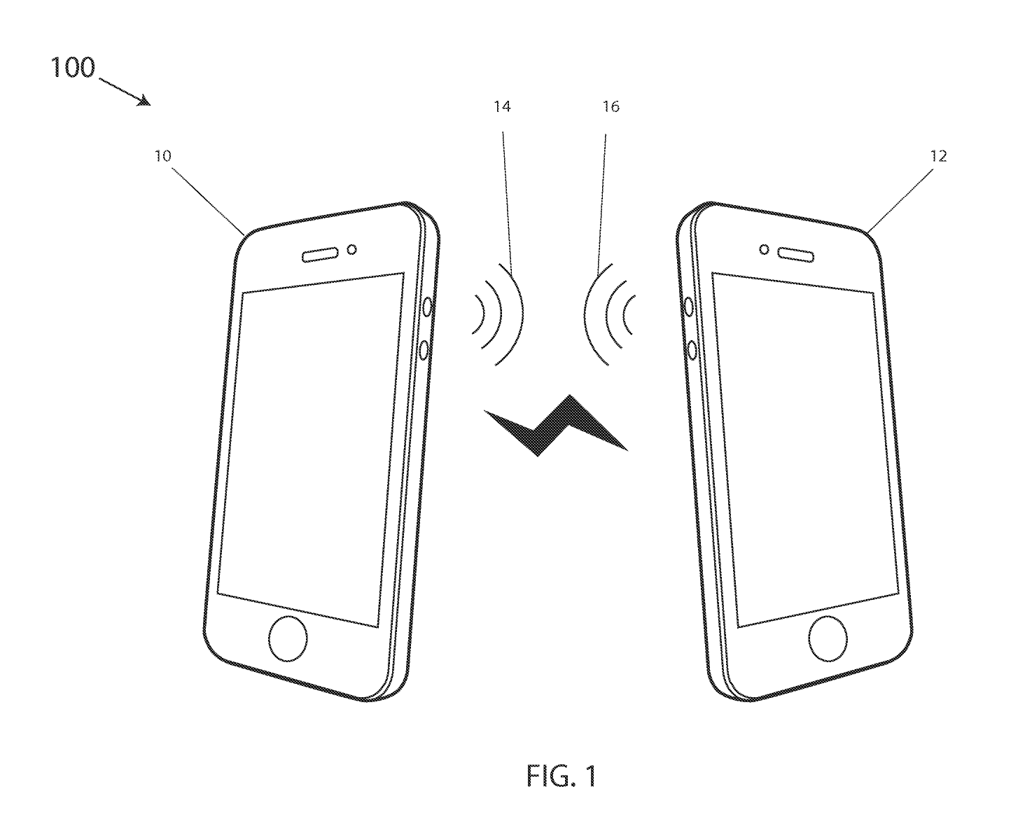

FIG. 2 is a plan view of a phone screen used in the current invention.

FIG. 3 is a block diagram of the inductive wireless power system.

FIG. 4 is a block diagram of the transmitter.

FIG. 5 is a block diagram of the receiver.

### DETAILED DESCRIPTION OF THE PREFERRED EMBODIMENT

As generally understood, system 100 includes a first electronic device 10 and a second electronic device 12 are utilized in the present invention. In one embodiment, each device is utilized. In another embodiment, either first electronic device 10 and/or second electronic device 12 is a device case configured with a rechargeable power supply. Each phone is constructed and arranges as described herein with particular hardware and software stored on a non-transitory computer readable medium in order to accomplish the goals of the present invention. A default proximity distance is breached and each of first phone 10 and a second phone 12 actuate a software sequence to alert that a charging phone is within the boundary of the proximity distance. By way of example only, a proximity threshold of 12 inches is established. Once a device configured for exchange is detected within 12 inches or less, the power share software is automatically actuated. In one embodiment, the actuation is done manually by a user and the phone looks for the nearby phone. First phone 10 has signal 14 and a second phone 12 has signal 16.

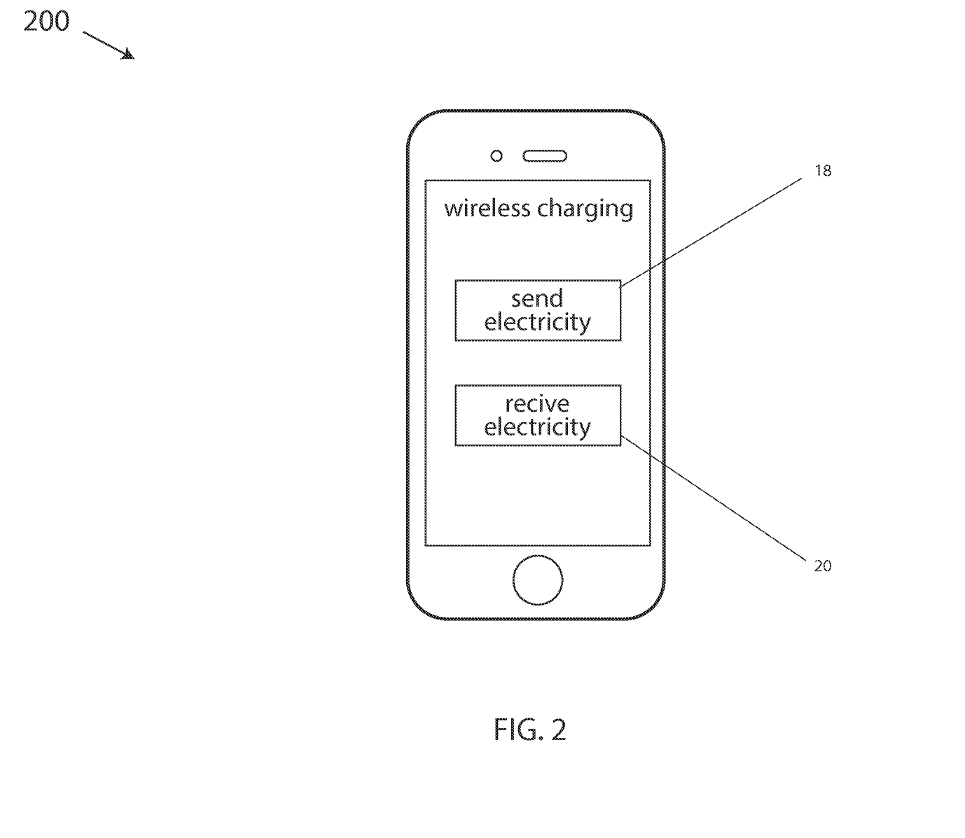

As demonstrated by way of example in FIG. 2, one embodiment includes a graphical user interface appears on a phone and prompts a user to select first prompt 18, whether to send electricity, or second prompt 20 to receive electricity. One each phone has made a selection, transmission begins. In one embodiment, a software-controlled transmitter can meter the amount of power transferred.

By way of illustrative example only, first phone 10 has 70% battery life remaining and a second phone 12 has 5% battery life remaining. User of first phone 10 instructs the software to transfer power only until first phone 10 has 45% battery life remaining. In configuring this way, the system of the present invention provides that first phone 10 will not transmit power to the point that all stored power is transferred.

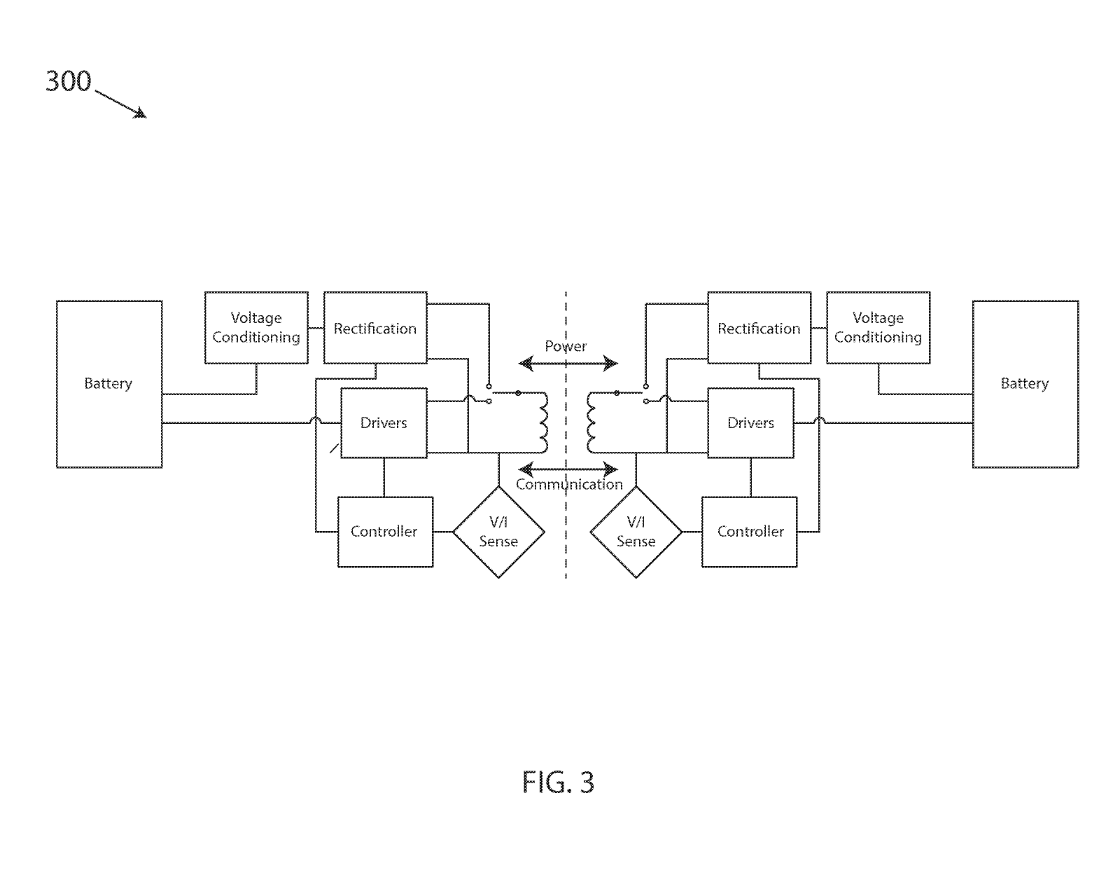

In one embodiment, the present invention is a smart dual wireless charger system between two generic mobile devices. FIG. 3 presents a block diagram of a double side inductive wireless power system. The system has two devices that can exchange power in both directions. The goal is to charge the battery of one side with the energy stored in the battery from the other side. To achieve this, both devices communicate each other using a communication protocol through the coil. The main building blocks of every device include:

Transmitter

Receiver

Switch

Controller

Coil

Battery

Communication protocol

A wireless power system of the invention includes a charging pad (transmitter or primary) and receiver (secondary-side equipment). Coils in both, the charging pad and the receiver are magnetically coupled when the two devices either are in operative proximity one to another, or make contact. Power transfers from transmitter to receiver via coupled inductors (e.g. an air core transformer). The amount of power transferred is controlled by sending feedback communication (for example, error signals) to the primary device to increase or decrease power. In one embodiment, the transfer amount is automated. The transmitter is powered off most of the time, only occasionally waking to see if a receiver is present. When a receiver authenticates itself, the transmitter remains powered on. In one embodiment, one or both devices generate an acknowledgement of power transfer. In another embodiment, a manual operation initiates and terminates the transfer. With both manual and automated power transfer, it is contemplated transfer be directly device to device, device to a charging case, or from charging case to charging case.

To archive the transfer of power in both directions, every device incorporates a transmitter, a receiver, and a switch for switching between transmit and receive. The device operates either as a transmitter or as a receiver at a certain instant of time. When two devices are close, a communication is established between both controllers through the coils to negotiate who is going to act as a transmitter and who as a receiver. The decision is based on the battery level of each device.

Power is transferred from transmitter to receiver via a coupled magnetic field that is created when an ac-current flows through the transmitter coil. If a receiver coil is in close proximity, a significant portion of the transmitter field lines will be coupled to the receiver coil. These coupled field lines create an ac-current in the secondary, which can be rectified to produce a dc voltage, resulting in a power source for a cell phone or other portable device.

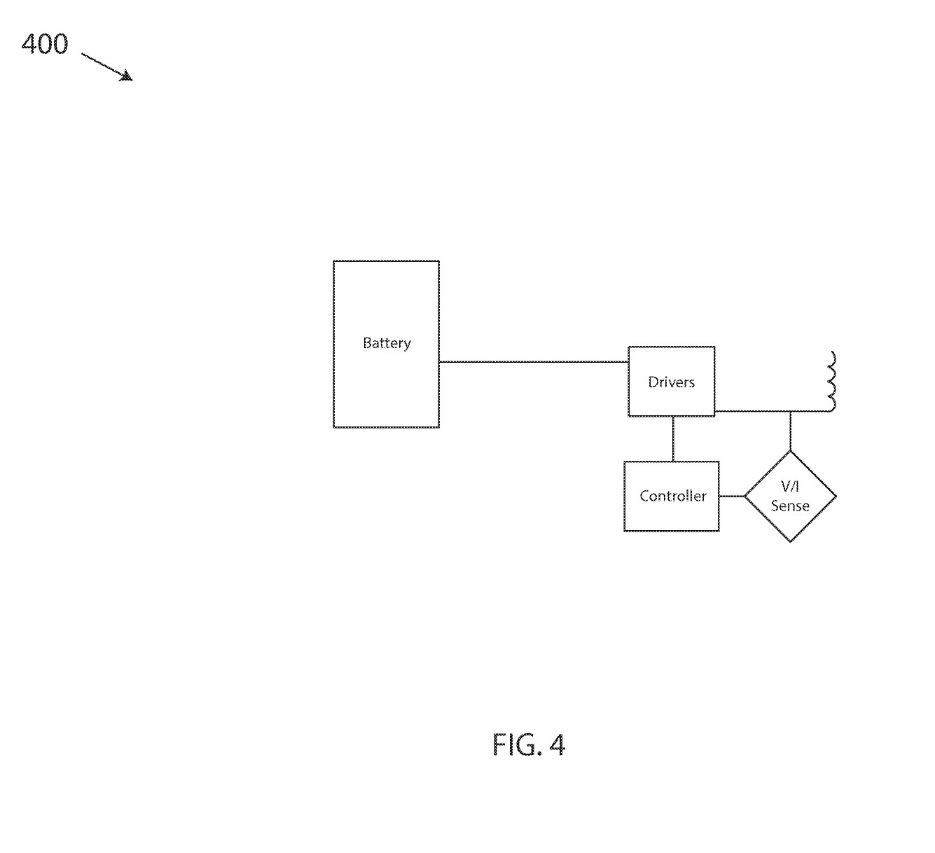

The transmitter includes a battery, driver, transmit coil, voltage and current sensing, and controller as shown in the FIG. 4.

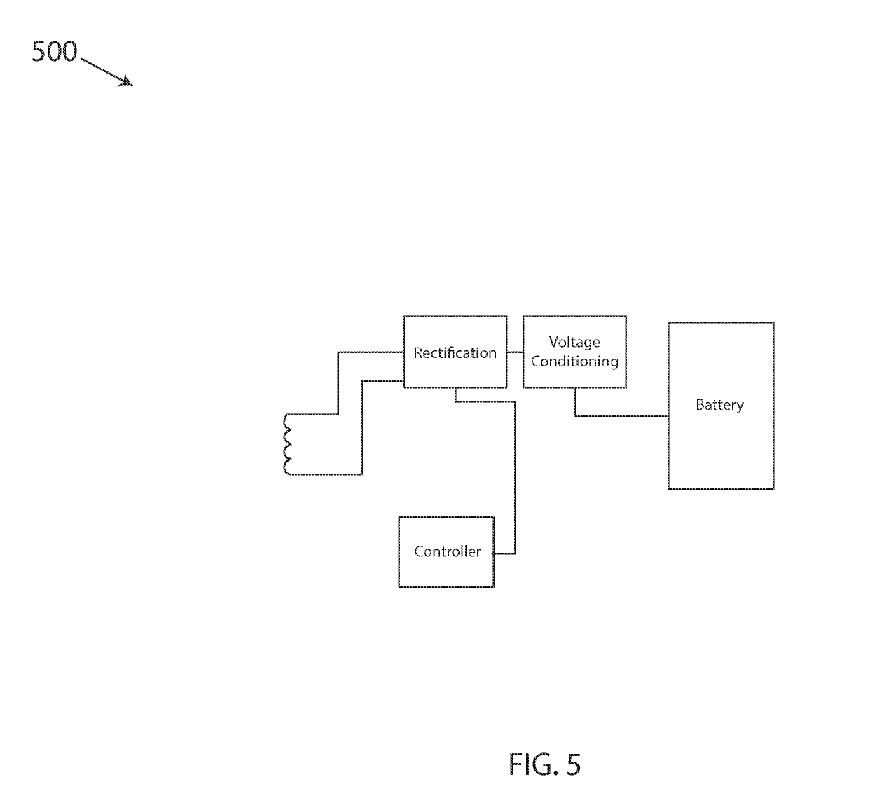

The receiver includes a receive coil, rectification circuit, voltage conditioning (that is, regulation), and a controller. The load for this system could be any battery-powered device, such as a cell phone handset. FIG. 5 shows the block diagram of the receiver architecture.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

What is claimed is:

1. A system for wireless charging comprising:
a first electronic mobile device;
a second electronic mobile device;
wherein each of said first and second electronic mobile devices are constructed and arranged to selectively transmit and receive power to a battery incorporated therewith.

2. The system of claim 1 wherein each electronic mobile device contains coils constructed and arranged to wirelessly send electrical power by transmitter to receiver via coupled inductors.

3. The system of claim 1 wherein power is transferred from transmitter to receiver via a coupled magnetic field that is created when current flows through a transmitter coil.

4. The system of claim 1 wherein said electronic mobile device is a cell phone, smart phone, tablet computer, camera, microprocessor enabled hand-held device, or combinations thereof.

5. The system of claim 1 where power transfer is initiated and stopped manually.

6. The system of claim 1 where power transfer is initiated and stopped automatically.

7. The system of claim 1 where power transfer is controlled by user selected parameters including at least one of battery power level of transmitting device, battery power level of receiving device, transfer rate, transfer time, or combinations thereof.
